(19) United States
(12) Patent Application Publication
(10) Pub. No.: US 2003/0163359 A1
(43) Pub. Date: Aug. 28, 2003

(54) Apparatus for distributing an advertisement

(76) Inventor: Takashi Kanesaka, Ichikawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/365,406

(22) Filed: Feb. 13, 2003

(30) Foreign Application Priority Data
Feb. 28, 2002 (JP) 2002-053772

(51) Int. Cl. G06F 17/60

(52) U.S. Cl. 705/8

(57) ABSTRACT

An advertisement distributing apparatus 21 capable of sending e-mails to cellular telephones, which comprises a registrant file 41 for registering users possessing cellular telephones, a purchase history file 42 for compiling purchase histories, a behavior pattern file 43 for compiling the behaviors of registrants using GPS (Global Positioning Systems), a registrant needs file 44 comprising genres and the like set by registrants, and an advertisement request file 46 containing advertisement data to be distributed, and being constituted such that registrants to whom advertisements are to be distributed are extracted from purchase history file 42 and behavior pattern file 43, as well as from advertisement request file 46.

### BACKGROUND OF THE INVENTION

1. Field of the Invention

The present invention relates to an advertisement distributing apparatus for distributing an advertisement to mobile communications devices, and to a distribution method therefor, as well as a mobile communications device, which receives the distributed advertisement.

2. Description of the Related Art

Registering permission in advance to distribute direct mail by genre to users can be cited as a conventional example of what is called push advertising, whereby an advertisement selected by a distributor is sent to user-owned terminal devices. By-genre distribution permission is used for classifying registered users into prearranged groups. Then, only advertisements for products or services with a high likelihood of being received by users belonging to these groups are distributed as direct mail to the users' terminal devices. This makes it possible for users to receive only advertisements for products and so forth that they themselves want, and enables advertisers to carry out sales campaigns efficiently.

As one example of an advertisement distribution service such as this, the distribution of local information via e-mail to the cellular telephones of users when users, who have registered their permission for by-genre distribution of advertisements, pass through automated ticket gates is under study. In a service such as this, user identification is performed by a distribution center acquiring the user's ID embedded in advance in his commutation ticket when the automated ticket gate processes the commutation ticket. Further, the present location of a user is presumed to be the station at which the automated ticket gate that processed this commutation ticket is installed. Once the distribution center acquires the user's ID, it distributes information about the locale surrounding that station to a cellular telephone. A user can receive advertisements of products and the like that he is interested in, and can receive advertisements about stores and the like in the area immediately surrounding his present location (the station).

However, although an advertising method such as this makes it possible to provide advertisements that are more likely to satisfy users the more the advertised product genres are subdivided, specifying the information that a user really wants from the genres that a user registers of his own volition is difficult. Coaxing out latent needs that are not obvious to a user is especially hard. Further, since a user's needs are constantly changing, it is desirable that genre settings be changed each time needs change, but since setting changes are troublesome for users, it is difficult to distribute advertisements that rapidly correspond to changing needs.

In addition, distributing advertisements via e-mail each time a user passes through an automated ticket gate cannot be called a suitable advertisement distribution method. This is because the precise location of the user cannot be gleaned solely from the information generated by his passing through the automated ticket gate. For example, he could be at the west exit of the station, or at the east exit, and it is also not possible to obtain information as to whether or not the user will still be in the station area in an hour's time.

### SUMMARY OF THE INVENTION

An object of the present invention is to appropriately and accurately distribute advertisements that users need. A further object of the present invention is to reliably grasp tendencies, such as the behavior of users, in order to make appropriate and accurate advertisement distribution a possibility.

An advertisement distributing apparatus, which has a processing portion that is capable of sending e-mails to mobile communications devices, can be cited as means for solving for the above-mentioned problems. This advertisement distributing apparatus has a registrant file for registering users, who possess mobile communications devices, a purchase history file for compiling purchase histories, a behavior pattern file for compiling the activities of registrants using GPS (Global Positioning Systems), a needs file for registering registrant-set genres and so forth, and an advertisement request file comprising advertising data to be distributed, and is constituted such that registrants to whom an advertisement is to be distributed are extracted from the purchase history file, behavior pattern file, and needs file, as well as the advertisement request file. The purchase history file and behavior pattern file can be updated daily in accordance with the activities of registrants. By constantly updating such files, it is possible to reliably grasp registrants' needs, and changes thereto. In particular, using GPS makes specifying the present locations of registrants easy and accurate. Furthermore, compiling a non-purchase history, which is a history of products about which advertisements were received but which were not purchased, will contribute towards an accurate understanding of needs. Further, if registrants are able to select whether or not purchase histories are created, it will be possible to protect the privacy of the registrants. In this case, to facilitate confirmation of the results of selections, it is desirable that selection results be displayed on the mobile communications devices used by the registrants.

### BRIEF DESCRIPTION OF THE DRAWINGS

FIG. 1 is a diagram showing the overall constitution of an advertisement distributing system in an embodiment of the present invention;

FIG. 2 is a block diagram showing the constitution of an advertisement distributing apparatus;

FIG. 3 is a block diagram that analyzes the functionality of an advertisement distributing apparatus;

FIG. 4 is a diagram showing the constitution of a registrant file;

FIG. 5 is a block diagram showing the constitution of a cellular telephone as a mobile communications device;

FIG. 6 is a flowchart of the processing that takes place in an advertisement distributing system;

FIG. 7 is a flowchart of the process for setting a registrant's needs; and

FIG. 8 is a diagram showing an example of a display screen of a cellular telephone as a mobile communications device.

### DESCRIPTION OF THE PREFERRED EMBODIMENTS

The embodiments of the present invention will be explained in detail while referring to the figures.

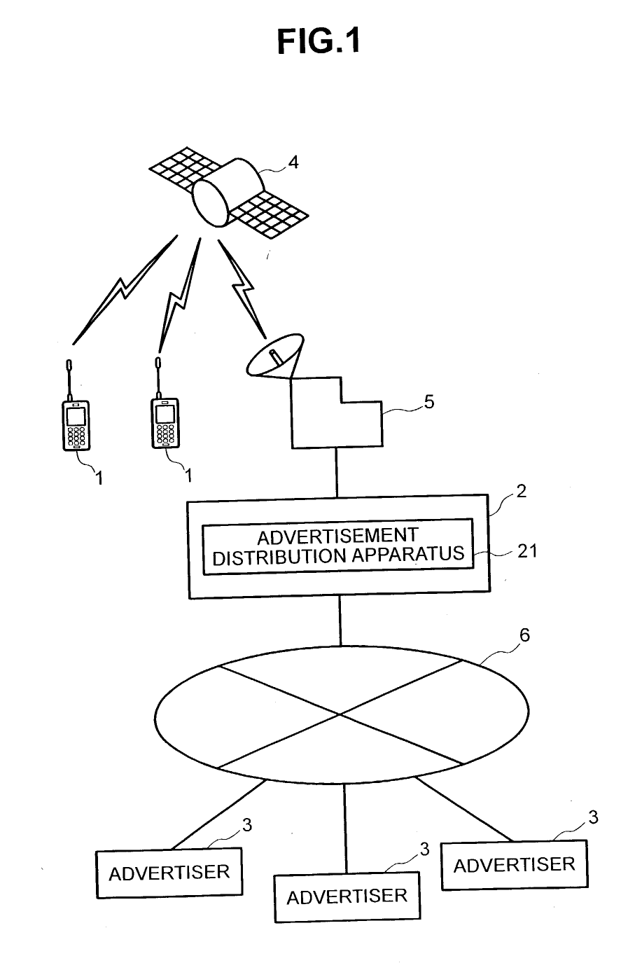

FIG. 1 is a diagram of the overall constitution of an advertisement distributing system of this embodiment.

An advertisement distributing system for distributing an advertisement to mobile communications devices of users, as shown in FIG. 1, is constituted comprising cellular telephones 1, which are mobile communications devices that users carry around, a distribution center 2 for distributing advertisements to cellular telephones 1 using GPS (Global Positioning Systems), advertisers 3, which are stores and the like that request the distribution center 2 to distribute advertisements, and a transceiving facility 5 for transmitting and receiving information to and from a GPS satellite 4. Distribution center 2 and advertisers 3 in FIG. 1 can be connected online via the Internet 6, which is an open communications network, but the transfer of data can also be performed off line. Distribution center 2 and transceiving facility 5 are connected by a leased line, but can also make use of an open communications network. Furthermore, transceiving facility 5 calculates the present locations of cellular telephones 1, and comprises a positioning server, which is a computer for outputting the results thereof.

(Distribution Center)

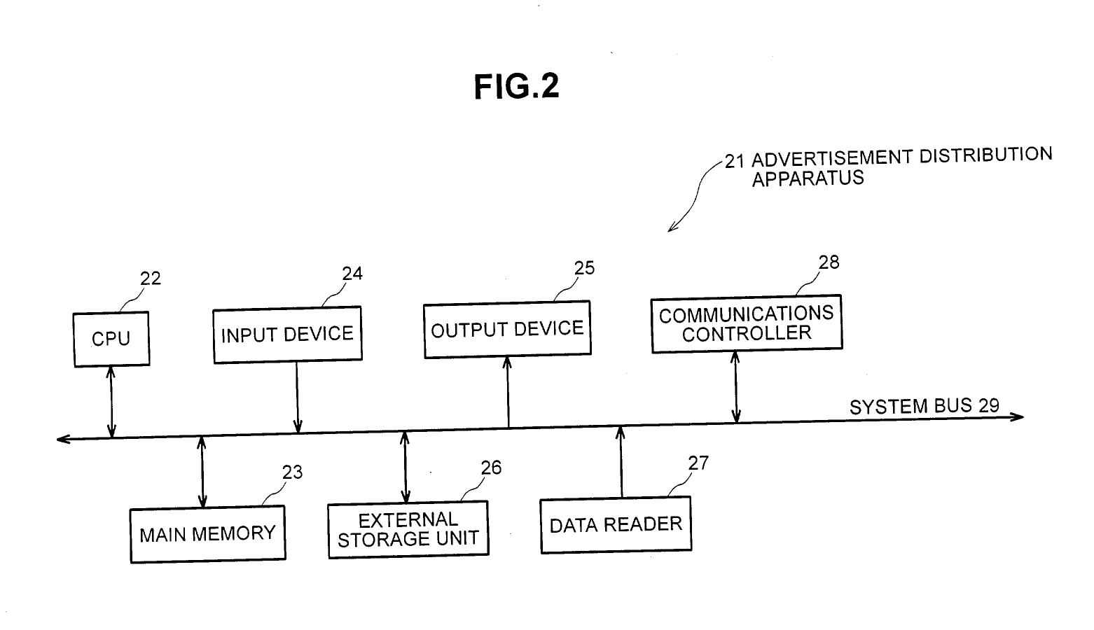

FIG. 2 is a block diagram showing the constitution of an advertisement distributing apparatus 21 comprising a computer system used at distribution center 2. This advertisement distributing apparatus 21 has a CPU (Central Processor Unit) 22, a main memory 23, an input device 24, and output device 25, an external storage unit 26, a data reader 27, and a communications controller 28, and is constituted such that each of these is connected to a common system bus 29. CPU 22 controls overall operation. Main memory 23 is memory into which various processing programs and data comprising the OS (Operating System) is loaded, and working memory is also included therein. Input device 24 is a mouse, keyboards or the like. Output device 25 is a display or printer. External storage unit 26 is a storage unit, such as a hard disk drive unit, for storing various processing programs and data, and a variety of files, which will be explained hereinbelow. Data reader 27 is a device for reading various processing programs and data, and is a CD-ROM reader or the like. A modem or router, having functions for carrying out communications in accordance with TCP/IP (Transport Control Protocol/Internet Protocol), can be cited as communications controller 28.

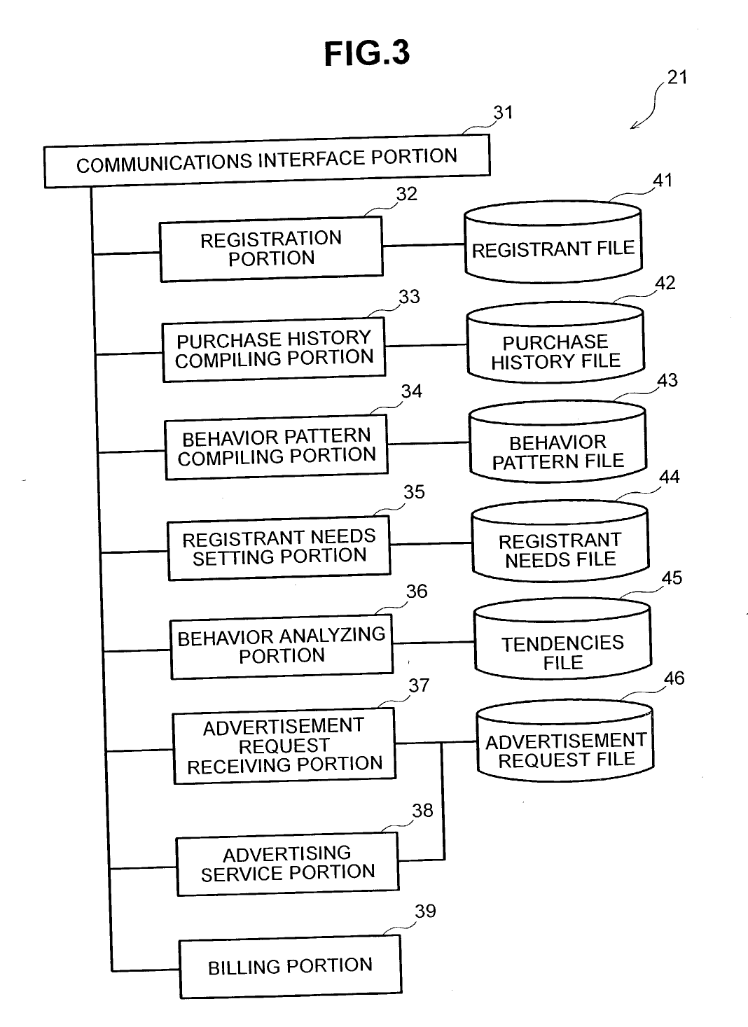

The functionality achieved by starting up and running programs, and processing data in an advertisement distributing apparatus 21 such as this will be explained using the functionality diagram shown in FIG. 3. Only those parts related to the present invention have been extracted and are shown in FIG. 3.

As shown in FIG. 3, advertisement distributing apparatus 21 has a communications interface portion 31, a registering portion 32, a purchase history compiling portion 33, a behavior pattern compiling portion 34, a registrant needs setting portion 35, a behavior analyzing portion 36, an advertisement request receiving portion 37, an advertising service portion 38, a billing portion 39, and a registrant file 41, purchase history file 42, behavior pattern file 43, registrant needs files 44, tendencies file 45, and advertisement request file 46, which are files. Respective portions 31 through 39 are realized primarily by calling up programs stored in external storage unit 26 of FIG. 2 to CPU 22 and main memory 23. Respective files 41 through 46 are stored in external storage unit 26.

Communications interface portion 31 is the part that manages the interface with the Internet 6 for transferring data between users of cellular telephones 1 and advertisers 3 shown in FIG. 1, and is controlled by the co-operation of communications controller 28 and CPU 22 and so forth of FIG. 2.

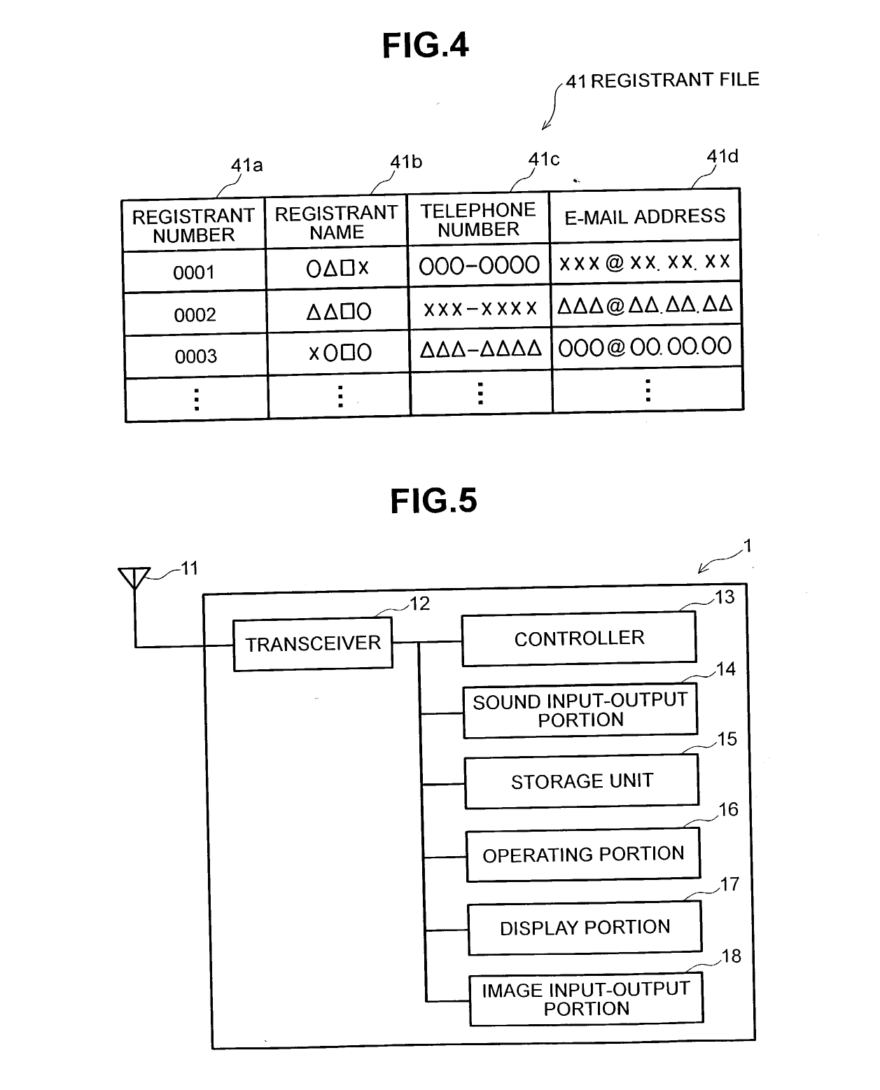

Registering portion 32 carries out the processing for registering users in an advertisement distributing system using cellular telephones 1, and the processing for registering advertisers 3. User registration data processed by registering portion 32 is stored in registrant file 41 for each user and each advertiser 3. An example of registrant file 41 is shown in FIG. 4. FIG. 4 is a registrant file 41 created for users (hereinafter called registrants) registered in this system, and has a constitution such that, a distribution center assigns a unique registrant number 41a to a registrant, and data corresponding to the respective items of the name 41b, telephone number 41c and e-mail address 41d of a registrant are registered (stored) relative to this registrant number 41a. Further, in the case of an advertiser 3, a registration number, name, point of contact, and information concerning type of business and billing method are stored.

Purchase history compiling portion 33 carries out processing for compiling the purchasing histories of registrants, and constructs a database in purchase history file 42. A purchase history is a collection of information concerning whether or not electronic commerce transactions have been carried out in accordance with advertisements distributed primarily by an advertisement distributing system, and is constantly being updated. In this embodiment, “Purchase” is used to signify a case in which an electronic commerce transaction was carried out within a fixed period of time for a product or service related to a distributed advertisement, “non-purchase” is used to signify a case in which an advertisement was distributed but an electronic commerce transaction was not carried out within a fixed period of time, and a purchase history is prepared by compiling records of non-purchases. A purchase history file 42 of this type comprises a distribution file for registering, for each above-mentioned registrant number 41a, advertisements distributed via a process to be explained hereinbelow, and a non-purchase file for registering only those advertisements of the advertisements registered in the distribution file determined to be non-purchases, together with the genre thereof. Furthermore, a purchase history can be prepared by compiling only records of completed purchases, and a purchase history can be prepared by compiling the histories of purchases and non-purchases, respectively.

Here, for a registrant, who has only been registered for a short time, and for whom a purchase history has not been prepared, it is necessary to prepare and register the initial data of a purchase history in purchase history file 42. A purchase history acquired from a credit card company can be cited as initial data. This purchase history is created from the types of products and services, which a registrant purchased using a credit card, and the frequency of these purchases. A registrant's name, credit card number, ID for electronic commerce transactions and so forth can be put to good use for making inquiries about a registrant at a credit card company, and credit card numbers and the like are registered in registrant file 41 as needed. Further, when preparing the initial data, data on withdrawals and deposits can be obtained from banks, information can be obtained from diverse businesses, such as rental video shops and shopping centers, and a registrant or a distribution center 2 can utilize this data either selectively or in combination.

Behavior pattern compiling portion 34 creates behavior patterns by periodically acquiring via GPS the location of cellular telephones 1, that is, the location of registrants, and storing these patterns in behavior pattern file 43 for each registrant. This is data showing the present locations of registrants, and utilizes location data indicated by longitude, latitude and altitude, and data, which is map data sent from the positioning server of transceiving facility 5. A behavior pattern is obtained by matching up location data with map data, and extracts for each registrant those areas where a registrant is most active, stores visited most often and the types of business thereof, the times of day when movement is most frequent, and means of movement (on foot, bicycle, car, and so forth) as calculated from travelling speed. Furthermore, distribution center 2 can also have a positioning server, and the processing for behavior pattern compiling portion 34 can also be outsourced to an outside organization such as transceiving facility 5 of FIG. 1. By creating registrant behavior patterns in this manner, it becomes possible for registrants to receive a distributed advertisement at desired locations. To put it simply, this is because, in the analysis carried out in the behavior analyzing portion 36 to be explained hereinbelow, locations that registrants simply pass through or visit infrequently are not emphasized, but places visited with high frequency, and places where registrants stay for long periods of time are strongly reflected in the behavior analyses of registrants, making it easy for an advertisement to be distributed when registrants are in such places.

Registrant needs setting portion 35 carries out processing for registering, as registrant needs, data that a registrant sets of his own volition, and creating a registrant needs file 44. System settings and genre settings can be cited as registrant needs.

The propriety of “Receive Distribution of Advertisements?”, the propriety of “Compile Behavior Patterns via GPS?” and the propriety of “Compile Purchase History?” can be cited as system settings. “YES to All” or “NO to All” can be set for these for the respective items, or they can be set separately (individual settings) for each item of time of day, day of week, date, and place (area), such as the company or at home. When “NO to All” is set for “Receive Distribution of Advertisement?”, advertising service portion 38, which will be explained hereinbelow, does not distribute advertisements to that registrant. When individual settings are made, advertising service portion 38 carries out processing by individual item, such as, for example, not distributing advertisements at a specified time of day or day of the week, and not distributing advertisements while a registrant is in a specified location. Similarly, when either “NO to All” or an individual setting of “NO” is given for “Compile Behavior Pattern Via GPS?” the compilation of behavior patterns is cancelled in accordance with such settings. Furthermore, similarly, when either “NO to All.” or an individual setting of “NO” is given for “Compile Purchase History?”, the compilation of a purchase history is cancelled in accordance with such settings.

Genre settings are settings for specifying the genre of advertisement to be distributed. As examples of genre, items for making classifications based on types of products or services, such as “Food,” “Clothing,” “Leisure” and “Business,” or items for classifying individuals into a plurality of segments based on sociological elements, such as “Age,” “Gender,” “Occupation” and “Family Status,” or items for making classifications based on the method of providing a product or service, such as location or type of business, and the time of day that the provision of a product will be received can be given. In addition, objects that a registrant possesses, or objects that he is interested in, such as an automobile for personal use, can also be added.

Behavior analyzing portion 36 extracts registrants having specified tendencies from purchase history file 42, behavior pattern file 43, and registrant needs file 44, classifies the extracted registrants as one group, and registers them in tendencies file 45. Analysis data constituted from keywords characterizing groups that match advertising targets are utilized in extraction. As analysis data, individual keywords and combinations of keywords, such as “Male,” “Female Interested in Clothing,” “Person in 20's Who Has a Car and Likes Going Out at Night,” “Person Who Spends a Lot on Food” and “Person Who Visits the OOOO Area Often” are available in the behavior analyzing portion 36. This analysis data takes into consideration advertising targets, and is added and modified in the behavior analyzing portion 36 as needed. Further, when registrants that match a specified product genre are extracted from purchase history file 42, or when registrants that match a specified time of day or area are extracted from behavior pattern file 43, behavior analyzing portion 36 can perform a frequency calculation. For example, registrants, for whom the amount of money spent and purchasing frequency for products, which are classified under food, are statistically high according to purchase history file 42, are determined to “Spend a Lot on Food.” Registrants, whose levels of activity are above a fixed value from 18:00 to 25:00 hours according to behavior pattern file 43, are judged to be “Night Persons.”

Advertisement request receiving portion 37 carries out processing for receiving requests from advertisers 3. A request is carried out by attaching target data for specifying a registrant group to whom advertisements should be sent to data of advertisements that are actually distributed to registrants. Target data comprises either one or a plurality of keywords constituting the analysis data in behavior pattern file 43 selected by an advertiser 3. This target data can be determined and attached to advertisement data by distribution center 2 without being specified by an advertiser 3. The number of e-mails distributed can be specified instead of target data, or in combination with it. These data are stored in advertisement request file 46. An advertisement request file 46 is created for each advertiser 3 and for each request, and after a request has been completed, or after a fixed period of time has elapsed, the contents of the files are rearranged by advertisement request receiving portion 37.

Advertising service portion 38 acquires from advertisement request file 46 advertiser names, advertisement data, target data, and, as needed, data on the number of e-mails distributed. Furthermore, in addition to searching tendencies file 45 and extracting the e-mail addresses of pertinent registrants based on acquired target data, advertising service portion 38 also distributes advertisement data to these e-mail addresses. Further, data related to a distributed advertisement, and a distribution record comprising a list of registrants to whom distribution was made are transferred to purchase history compiling portion 33 for compiling purchase histories.

Billing portion 39 carries out billing to advertisers 3 in return for the distribution of advertisements, and the charges are applied to the operation of the advertisement distributing system. As billing modes, there can be cited a variable (fluctuating) system, in which charges vary according to the amount of information per advertisement-distributing e-mail message and the number of emails distributed, a fixed system which sets charges according to a specified period of time, such as monthly or yearly, and a system that is a combination of the variable system and fixed system, wherein basic charges are fixed, and charges are levied only for that amount of data that exceeds a fixed quantity. Further, compensation for when at the least one copy of tendencies file 45 is provided to an advertiser 3 for marketing purposes in a form that keeps personal data confidential is also calculated by billing portion 39.

(Cellular Telephones)

A cellular telephone 1 utilized in an advertisement distributing system will be explained using the simplified block diagram shown in FIG. 5.

As shown in FIG. 5, a cellular telephone 1 comprises an antenna 11 and transceiver 12 for transmitting and receiving data, a controller 13 for carrying out various processing, a sound input-output portion 14 for processing sounds, a storage unit 15, operating portion 16, and a display portion 17 for displaying data. Furthermore, an image input-output portion 18, which is not a required component, is also shown in FIG. 5.

Antenna 11 is provided inside the main unit of cellular telephone 1 in an extendable/retractable condition, and is utilized to receive and transmit data-multiplexed radio waves from a GPS satellite 4 (Refer to FIG. 1). As examples of data obtained by using this antenna 11, that is, received data, there are sound data, location data corresponding to latitude and longitude, e-mails comprising advertisements, Web data and so forth. As examples of data sent using this antenna 11, that is, transmitted data, there are sound data, data for creating purchase histories, and various other data, such as e-mails.

Transceiver 12 comprises a filter, and electric and electronic circuitry, extracts the above-mentioned received data from radio waves received via antenna 11, and outputs same to sound input-output portion 14 and so forth.

Controller 13 is constituted from a CPU, ROM (Read Only Memory), RAM (Random Access Memory), and other circuitry. Controller 13 controls in a generalized manner the basic functions of cellular telephone 1, such as control of the transmission and receiving of calls, by deploying control programs stored in ROM to the CPU and RAM and starting them up. Further, controller 13 also processes location data acquired from GPS satellite 4, and carries out processing for displaying the present location of the user, who possesses cellular telephone 1, together with a map or the like.

Sound input-output portion 14 is constituted from a speaker, microphone, and other specified circuitry, and controls the input and output of sound data. Data, such as an incoming call ringer, music and voice used in calling, which are acquired via GPS satellite 4 and outputted via the speaker, can be given as the sound data outputted from the speaker. As for data inputted via the microphone, there is the voice data of a user, who carries out calls on this cellular telephone 1. Further, it is desirable that sound input-output portion 14 be equipped with a sound output terminal, which makes it possible to select sound output to an external device not shown in the figure.

Storage unit 15 is memory for storing telephone numbers, a history of incoming calls, and applications downloaded to manifest additional functionality in cellular telephone 1. Processes for storing and reading out data on storage unit 15 are carried out under the control of controller 13.

Operating portion 16 is constituted from a numeric key pad, function keys, a dial button and so forth, and is provided for inputting telephone numbers and selecting applications to be opened and started up by controller 13.

Display portion 17 is constituted from a liquid crystal display or the like, which is capable of displaying the text and images comprising received data. Further, a telephone number selected via operating portion 16 is also displayed on display portion 17.

Image input-output portion 18 is utilized when outputting text and images comprising received data using an external device. A display larger than the above-mentioned display portion 17, or a device comprising operating means linked to such a display can be cited as examples of this external device. Further, by comprising image input-output portion 18, it becomes possible for the present invention to also connect to a camera for capturing images and the like to cellular telephone 1.

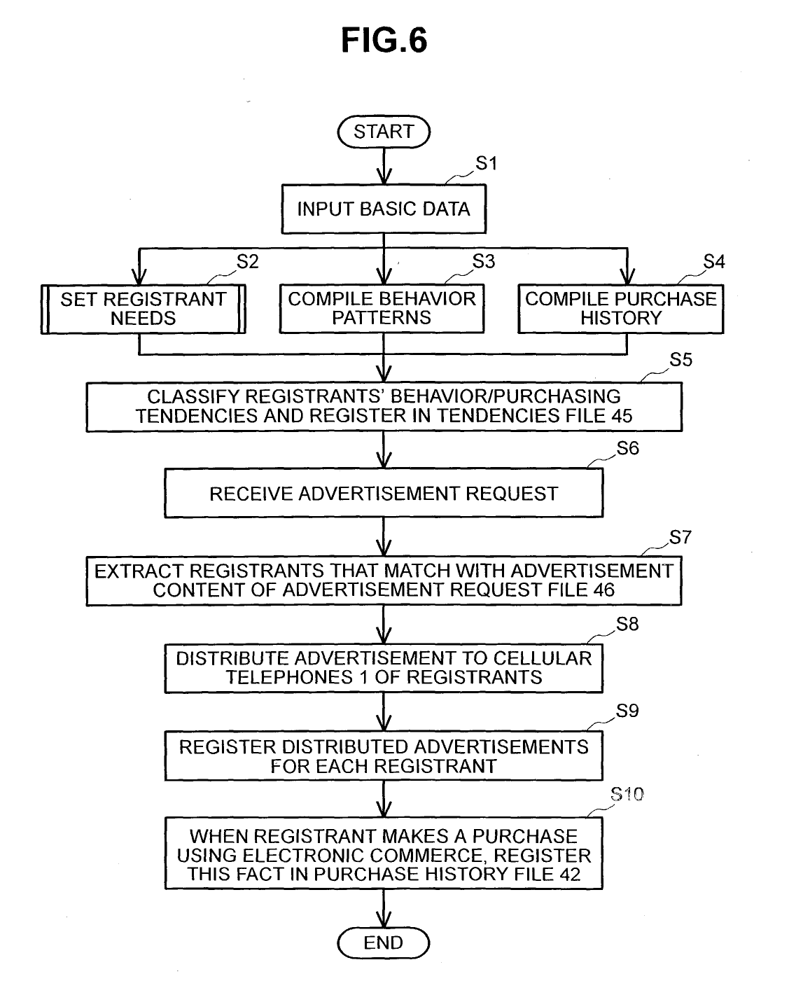

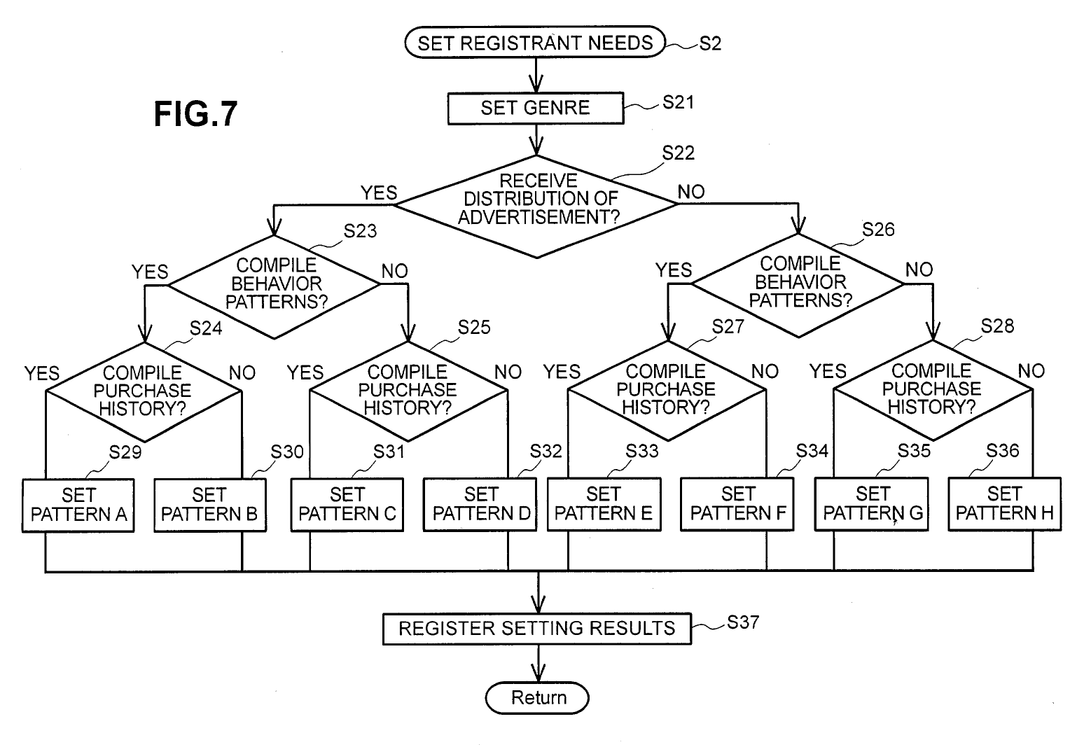

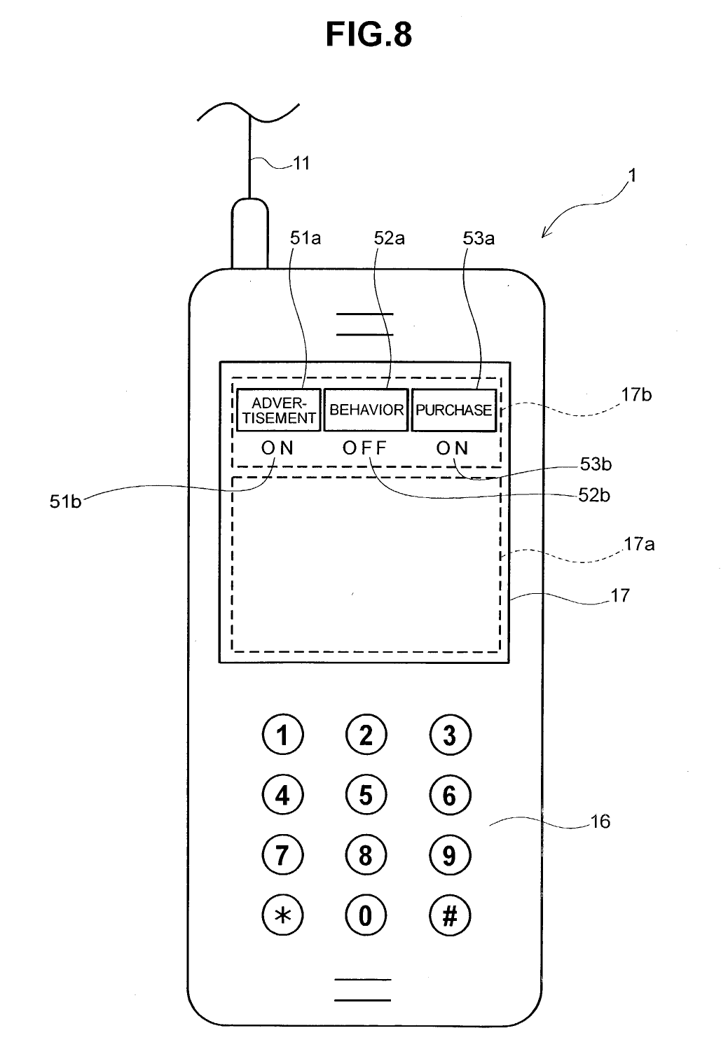

Next, the various processing carried out by an advertisement distributing system will be explained by referring primarily to FIG. 6 through FIG. 8. Furthermore, FIG. 6 is a flowchart describing the processes from user registration to the distribution of an advertisement, and FIG. 7 is a flowchart showing a portion of the processing of FIG. 6 in detail. FIG. 8 is a diagram showing an example of a cellular telephone 1 display during the processing of FIG. 7.

(Registering in the System)

The processing when a user of a cellular telephone 1 becomes a registrant by registering various information at distribution center 2 will be explained using Step S1 and Step S2 of FIG. 6.

First of all, a user, who would like to register in an advertisement distributing system, inputs basic data for user registration in Step S1. Basic data refers to the user's name, and his credit card number and the name of his credit card company, which are inputted as needed. This basic data is inputted using operating portion 16 of a cellular telephone 1, and is sent to distribution center 2 via GPS satellite 4 of FIG. 1. Distribution center 2 registers the received basic data in each pertinent item (for example, the user's name is registered in registrant name 41b) of registrant file 41 (FIG. 3).

Once inputting of basic data has been completed, in Step S2, distribution center 2 sends data requesting needs settings to cellular telephone 1. The user replies to each item using operating portion 16. Here, needs settings refers to the genre settings and system settings registered in the above-mentioned registrant needs file 44.

The needs settings of Step S2 will be explained in more detail using mainly the flowchart of FIG. 7. In FIG. 7, Step S21 is the genre settings, and Step S22 through Step S28 correspond to system settings. Furthermore, genre settings (Step S21) are items for carrying out classification based on the types of products and services mentioned hereinabove. System settings (Step S22-through Step S28) are the propriety of “Receive Distribution of Advertisements?”, the propriety of “Compile Behavior Pattern via GPS?” and the propriety of “Compile Purchase History?” The order in which these settings are processed can be changed.

The genre settings carried out in Step S21 are made by a registrant entering replies on an input form displayed on cellular telephone 1. The input form is provided by distribution center 2, and is processed by controller 13 and displayed on display portion 17 of cellular telephone 1 described in FIG. 5. Since a plurality of broad genres (for example, “Food,” “Transportation,” and so forth) are arranged and displayed as setting items on the initial screen of the input form, a registrant uses operating portion 16 to select the setting item he wants to respond to from among the setting items of the initial screen. An input screen for inputting more detailed information (for example, when “Food” has been selected, “Japanese Food,” “Western Food,” and so forth) is available for each setting item, and is displayed in accordance with a registrant's selection. This input screen is constituted from a text inputting field into which a registrant can freely input characters, and a selection field, which enables at the least one item to be selected from among a plurality of selection options. Further, an end of setting item for ending Step S21 by ending the setting of genre and sending the set data to distribution center 2 is provided in a selectable condition in each input screen and initial screen.

System settings carried out in Step S22 through Step S28 begin with the-selection of the propriety for “Receive Distribution of Advertisement?” in Step S22. When a registrant agrees to receive the distribution of an advertisement (YES), processing proceeds to Step S23, and the registrant selects propriety for “Compile Behavior Patterns?”. Conversely, when a registrant refuses to receive the distribution of an advertisement (NO in Step S22), an advertisement is not distributed to this registrant.

“Compile Behavior Patterns?” of Step S23 is the step for selecting whether or not behavior pattern compiling portion 34 of FIG. 3 will create a behavior pattern file 43 by compiling the location of a registrant based on data from a positioning server. When a registrant agrees to compilation (YES), a movement history of the registrant will be compiled thereafter, and processing proceeds to Step S24.

“Compile Purchase History?” of Step S24 is the step for selecting whether or not purchase history compiling portion 33 of FIG. 3 will compile a history of registrant non-purchases, and create of purchase history file 42. Furthermore, when a registrant elects to refuse compilation (NO) in the above-mentioned Step S23, the same processing is carried out for “Compile Purchase History?” of the subsequent Step S25.

Meanwhile, even when “NO” is inputted in Step S22, that is, when a registrant refuses to receive the distribution of an advertisement, the registrant can select the propriety for “Compile Behavior Patterns?” in Step S26, and for “Compile Purchase History?” in either Step S27 or Step S28 subsequent to Step S26. Settings for compiling behavior data and compiling a purchase history even when a registrant has refused to receive the distribution of an advertisement are possible because the refusal to receive the distribution of an advertisement is a temporary decision, and in the meantime purchase history file 42 and behavior pattern file 43 are augmented and put to good use in the subsequent distribution of advertisements to-this registrant. Furthermore, the processing of Step S26 is the same as that for Step S23, and the processing in Step S28 is the same as that of either Step S24 or Step S25.

After the results of system settings carried out as described hereinabove are set as below-described Pattern A through Pattern H in Step S29 through Step S36, these results are sent to distribution center 2, registered in registrant needs file 44 (Step S37), and this processing ends. Furthermore, individual settings, such as permission to distribute advertisements according to the time of day, as was described hereinabove, are carried out in accordance with the processing of Step S22 through Step S36.

The respective patterns set in Step S29 through Step S36 are grouped into the following eight patterns A through H.

Pattern A: Users who receive the distribution of advertisements while compiling behavior patterns and purchase histories (YES in all of Step S22, Step S23 and Step S24).

Pattern B: Users who receive the distribution of advertisements, and compile behavior patterns, but do not compile purchase histories (In Step S22 through Step S24, only Step S24 is NO).

Pattern C: Users who receive the distribution of advertisements, and compile purchase histories, but do not compile behavior patterns (In Steps S22, S23 and S25, only Step S23 is NO).

Pattern D: Users who receive the distribution of advertisements, but compile neither behavior patterns nor purchase histories (In Steps S22, S23 and S25, only Step S22 is YES).

Pattern E: Users who compile behavior patterns and purchase histories, but do not receive the distribution of advertisements (In Step S22, Step S26, and Step S27, only Step 22 is NO).

Pattern F: Users who compile behavior patterns, but do not receive the distribution of advertisements, and do not compile purchase histories (In Step S22, Step S26 and Step S27, only Step S26 is YES).

Pattern G: Users who compile purchase histories, but do not receive the distribution of advertisements, and do not compile behavior patterns (In Steps S22, Step S26 and Step S28, only Step S28 is YES).

Pattern H: Users who do not receive the distribution of advertisements, and do not compile either behavior patterns or purchase histories (NO in all of Step S22, Step S26 and Step S28).

Further, the results of system settings are displayed on display portion 17 of cellular telephone 1 such that a registrant can make visual confirmation. In FIG. 8, there are illustrated a display area 17a, in which e-mail messages are displayed, the telephone number of the calling/called party is displayed, and setting items are arranged and displayed, and a setting display area 17b, which is displayed in a corner portion of display portion 17. Setting display area 17b comprises boxes 51a, 52a, 53a, which comprise the characters “Advertisement”, “Behavior” and “Purchase”, and which enable a registrant to visually identify the items “Receive Distribution of Advertisement?”, “Compile Behavior Patterns?” and “Compile Purchase History?” by item, and setting character displays 51b, 52b, 53b, which are arranged and displayed correspondent to the respective items, and which display the propriety setting results for each item alternately as “ON” and “OFF”. The respective boxes 51a, 52a, 53a can also indicate the individual setting items using alphabet letters corresponding to the above-mentioned Japanese-language notations. User confirmation can also be facilitated by changing colors corresponding to ON/OFF switching, inverted displays or highlighted displays. The “ON/OFF” setting character displays 51b, 52b, 53b can also be omitted when using a display mode that corresponds to switching boxes 51a, 52a, 53a.

Furthermore, according to FIG. 8, because setting character display 51b corresponding to “Receive Distribution of Advertisement?” box 51a is “ON”, it is understood that the registrant agrees to receive the distribution of an advertisement. Further, since setting character display 52b corresponding to “Compile Behavior Patterns?” box 52a is “OFF”, the registrant is not allowing behavior patterns to be compiled. Furthermore, since setting character display 53b corresponding to “Compile Purchase History?” box 53a is “ON”, the registrant is allowing the compilation of a purchase history.

The switching of settings in setting display area 17b, that is, the processing of selections from Step S22 to Step S28 of FIG. 7 can be carried out at any time. The method for switching a system setting is to continue pressing for several seconds a pre-assigned button, such as the number button “1” on operating portion 16. In accordance with this operation, in addition to the switched-over setting result being sent to distribution center 2, it is also reflected in the display of the setting display area 17b. So as to enable this kind of switching to be performed easily, it is desirable that setting display area 17b be displayed on display portion 17 either at all times, or at the request of the registrant.

(Grouping of Tendencies)

Processing for grouping the tendencies of a registrant in order to specify the types of advertisements that should be distributed to the registrant, the distribution times and the distribution locations is carried out in Step S2 through Step S5 of FIG. 6. Furthermore, since Step S2 was described hereinabove, it will be omitted.

The compilation of behavior patterns of Step S3 is carried out using the above-mentioned behavior pattern compiling portion 34 and behavior pattern file 43. As a specific example, when, by matching up a registrant's GPS-specified present location data with map data, it is determined that this registrant is in a supermarket, and according to past logs, he spends a lot of time in this supermarket, a pattern, which states that the registrant “Spends a Lot of Time in Supermarkets”, is established.

The compilation of a purchase history of Step S4 is carried out by the above-mentioned purchase history compiling portion 33 and purchase history file 42. A frequently purchased item, for example, foodstuff, will be extracted by searching for items that are not purchased.

Then, tendencies file 45 registration of Step S5 is carried out by behavior analyzing portion 36 and tendencies file 45 based on data from Step S2 through Step S4. In the case of the above-mentioned example, “Spends a Lot of Time in Supermarkets” is understood to be a behavior pattern, and from the purchase history, it is understood that the registrant frequently purchases “Foodstuff.” When “Western Food” has been set as a registrant need, since “Purchases Western Foods at Supermarkets” is appropriate as analysis data that directly indicates the behavior and purchasing tendencies of this registrant, this registrant is registered in an appropriate group in tendencies file 45. Furthermore, as analysis data, “Purchases Japanese Food at Supermarkets,” which is similar analysis data, and “Purchases Foodstuff at Supermarkets, which is broad-concept analysis data, are also provided, and if “Japanese Food” becomes more frequent than “Western Food” in the future, the registrant will be reclassified into the group “Purchases Japanese Food at Supermarkets.” Similarly, when a notable difference in types of foods disappears, the registrant will be reclassified to the group “Purchases Food at Supermarkets.”

(Distribution of Advertisements)

The advertisement distribution process is described in Step S6 through Step S8 of FIG. 6.

The receiving of an advertisement request in Step S6 is carried out by the above-mentioned advertisement request receiving portion 37 receiving advertisement data and target data from an advertiser 3, and registering same in advertisement request file 46.

Step S7 carries out the extraction of registrants that match the advertisement content (target). Behavior analyzing portion 36 searches for a group that matches the target data in tendencies file 45, and extracts registrants belonging to this group.

Then, in Step S8, advertising service portion 38 distributes an advertisement to the extracted registrants as an e-mail message. Furthermore, in the distribution of an advertisement, the propriety of receiving the distribution of an advertisement (setting in Step S2), and the present location of registrants acquired via the compilation of behavior patterns (Step S3) are taken into consideration. For example, even if registrants match the target of an advertiser 3, an advertisement will not be distributed to registrants who have refused distribution at that location. Further, in the case of a limited-time advertisement, the advertisement will be distributed to registrants who are close to the advertiser's 3 stores.

For example, when a supermarket in Y City wants to advertise via an advertiser the fact that it will be having a sale on foodstuffs between 17:00 and 18:00 hours, and when the target data is “Y City, Foodstuffs, 15:00 to 18:00 hours,” advertising service portion 38 searches tendencies file 45 for registrants of groups for which “Foodstuff” is included as a keyword in the above-mentioned classification data, and, in addition, extracts from thereamong “Registrants who either live in Y City or within a prescribed distance from Y City.” Here, when the timing for distributing the advertisement is from around 17:00 hours to 18:00 hours, not only “Registrants who either live in Y City or within a prescribed distance from Y City” but also “Registrants who are presently either in Y City or within a prescribed distance from Y City” will also be the targets of advertisement distribution. The present location of registrants is determined based on location data acquired from a GPS positioning server. Furthermore, since the sale will end at 18:00 hours in this case, the advertising service portion terminates the distribution of the advertisement at either 18:00 hours or thereabouts.

In addition, when advertising the sale of a product for which there is a limited quantity, advertising service portion 38 will cancel distribution of the advertisement upon receiving a notification to that effect from the advertiser 3. Further, distribution can be carried out such that the number of products appearing in the advertisement changes from “200” to “50” and then to “0” in accordance with the sales status, and distribution can also be carried out such that the price of a product changes from “1000 yen” to “800 yen” in line with the passage of time. Advertisements such as this are effective for controlling inventory and clearing out a product.

In these cases, it is possible to employ a method by which a plurality of text and image data corresponding to product quantities and prices are provided in advertisement request file 46, and these parts are substituted as the need arises, and advertisements can also be filed in advertisement request file 46 for each product quantity or price. In the case of the latter, a product quantity or price is attached as an identifier to a file name, and when an advertiser 3 indicates a product quantity or the like, a search is carried out by product quantity or the like for an advertisement of that advertiser 3, and an advertisement of matching content is distributed.

Further, when the advertiser 3 is an automotive parts dealer with a store in X City, and the target data is “Use automobiles frequently, and X City is within range of movement,” advertising service portion 38 searches for “Registrants own automobiles” and “Registrants spend a lot of time traveling by automobile” groups, which are classified by analyzed data in tendencies file 45, also extracts “Registrants that live near X City” and/or “Registrants that visit X City frequently,” and distributes advertisements to registrants such as this. When the distribution of an advertisement is carried out by including registrant behavior patterns like this, it becomes possible for registrants to obtain information about places they wants to learn about. At this time, distributing such an advertisement only when pertinent registrants are located near X City makes it possible for registrants to receive the information they want in the desired location, and for advertisers 3, reliable advertising activities become possible.

(Distribution Post-Processing)

The processing subsequent to the carrying out of advertisement distribution as explained hereinabove is shown in Step S9 and Step S10 of FIG. 6.

The process for registering the advertisements which were sent for each registrant in Step S9 involves transferring a distribution record created by advertising service portion 38 to purchase history compiling portion 33, and registering same in purchase history file 42. This distribution record is constituted from data specifying registrants and distributed advertisements, respectively. Data for specifying registrants utilizes at the least one of registrant number, registrant name or registrant telephone number. The names and genre of products and the like can be cited as data for specifying advertisements that have been distributed.

When a registrant, who received an advertisement via the advertisement distribution process, purchases the advertised product, Step S10 is the process for utilizing cellular telephone 1 to notify distribution center 2 to that effect. For example, a setting is made such that, when cellular telephone 1 has a payment function, and an electronic commerce transaction is carried out via cellular telephone 1, an e-mail message is automatically sent to distribution center 2 upon completion of the transaction. Or, a registrant can notify distribution center 2 by manually operating cellular telephone 1, and either pressing a specified button, or returning the advertisement e-mail.

When distribution center 2 receives a notification from a registrant, purchase history compiling portion 33 compares the notified advertisement against data stored in the distribution file of purchase history file 42, and classifies the advertisements distributed to the registrant into advertisements that resulted in purchases (completed transactions) as a result of distribution, and advertisements that did not result in purchases. In this embodiment, a non-purchase history file is created for advertisements that did not result in purchases. A non-purchase history is compiled because, when a registrant, of his own volition, does not look at a distributed advertisement, this non-purchase history enables the genre of such advertisements to be reflected in tendencies file 45, thus proving useful in appropriately and accurately distributing advertisements that individual registrants truly desire.

Once an advertisement-based purchase history (in this case, a non-purchase history) has been created, it is converted to a purchase history created from the above-mentioned initial data, behavior analysis is carried out, and thereafter, advertising service portion 38 updates and augments the purchase history by acquiring, each time, advertisements that have been distributed, and advertisements of products and the like, which registrants have purchased. Since purchased products and the like are inferred based on the histories of non-purchases when behavior analyzing portion 36 performs analysis, analysis can be done by superimposing initial data at this time.

Furthermore, distribution post-processing (Steps S9 S10) is carried out following the distribution of an advertisement (Step S6 through Step S8), but system registration (Steps S1, S2) and the grouping of tendencies (Step S2 through Step S5) are carried out any time as needed, and system registration and tendency grouping are not necessarily carried out anew when an advertisement is distributed.

(Store Registration Request)

Store registration signifies the registration of an advertiser 3, and is carried out by storing and registering prescribed information in the above-mentioned registrant file 41 and advertisement request file 46 at the volition of an advertiser 3, but a registrant can also request that a store be registered.

In other words, there are stores that do not subscribe to an advertisement distributing system, but distribution center 2 can register stores that registrants like, and stores that registrants want information about in registrant file 41 in accordance with receiving a registration request e-mail from a registrant. Registering new stores like this is useful in compiling the behavior patterns of registrants, and in promoting advertisement requests. That is, registering new stores makes it possible to solve for the problem that small stores and the like do not always appear on the maps used by behavior pattern compiling portion 34, and cannot be reflected in tendencies file 45 no matter how many times registrants visit such stores or buy products at such stores, and also makes it possible to solve for the problem that distribution center 2 cannot engage in the advertisement distribution request business with stores that are not shown on maps. Accordingly, registrants can more appropriately and accurately receive the advertisements that they themselves want, and the stores can obtain information about interested customers, and can carry out appropriate and accurate advertising to such customers.

An advertisement distributing system such as this can distribute advertisements only to people that match the targets of advertisers 3 by virtue of advertisement distributing apparatus 21 compiling purchase histories, behavior patterns and preference settings of registrants, and grouping same according to prescribed keywords. In particular, since purchase histories and behavior patterns are updated and augmented all the time, it is possible to infer the latent needs of registrants. When inferred needs do not match up with the desires of registrants, this fact is fed back as non-purchase histories, thus enabling the distribution of advertisements that registrants genuinely want. In addition, since utilizing GPS enables the present locations of registrants to be detected with high precision, processing for distributing timely advertisements that correspond to registrants' present locations, as well as for not distributing advertisements in accordance with present locations becomes possible. In particular, inferring, from behavior patterns, those situations in which registrants are highly interested, and making it possible to set the propriety of receiving distributions at each location enables registrants to receive the information they want at the desired locations.

For advertisers 3, since it becomes possible to readily extract customers (registrants), which match targets for their products and the like, from groups that are refined and subdivided in real-time at distribution center 2, expenses can be held in check, and reliable sales promotion activities can be carried out. When advertising costs can be reduced, this also has the effect of enabling even one-man businesses and other advertisers 3 that cannot engage in large-scale advertising to put out advertisements, and of activating the economies of regions to which such advertisers 3 belong. Further, since most advertisements are distributed to registrants near stores, the time from advertisement distribution until actual purchase is shortened, making it possible to quickly learn the effectiveness of an advertisement.

Further, enabling registrants to set the settings of an advertisement distributing system, such as the propriety of receiving the distribution of an advertisement, makes possible the realization of advertisement distribution that provides a higher degree of satisfaction. In particular, since the constitution is such that setting results can be visually confirmed on registrants' cellular telephones 1, it is possible to achieve ease of registrant operation and ease of confirmation.

Furthermore, the present invention is not limited to the above-mentioned embodiment, and can be applied broadly.

For example, in the above-mentioned embodiment, the mobile communications device was a cellular telephone 1, but it can also be a Personal Digital Assistant (PDA), and the present invention can also be applied to a car navigation system that utilizes GPS.

Further, in addition to advertisements that record prices, which are directly related to purchases, advertisements can also comprise event announcements, and information for promoting product or service recognition. In an event announcement, the fact that the locations of registrants can be specified makes it easy to guide them to the event site.

With regard to compiling purchase histories, instead of using electronic commerce transactions carried out via cellular telephones 1, the present invention can also be constituted such that purchase data is notified to distribution center 2 from either stores or credit card companies when registrants pay by credit card or other such card.

Further, advertisers 3 can also add electronic coupons to advertisements. An electronic coupon can either be embedded in a part of an advertisement, or can be distributed as an attachment. Furnishing registrants with discounts and other benefits by presenting them with electronic coupons can enhance the response ratio by increasing the chances that registrants will look at distributed advertisements, and increasing the chances that they will purchase products and the like. From this standpoint, registrants can also be furnished with benefits that correspond to points by adding points in accordance with the number of distributed advertisement e-mails read, the number of times purchases are made resulting from advertisements, and the amount of money spent thereon. Confirmation that an e-mail has been read is achieved by sending a confirmation message to distribution center 2. The totaling of points can be realized by adding a totaling portion to the functional block diagram shown in FIG. 3 of the advertisement distributing apparatus 21 of distribution center 2.

According to the present-invention, registrants can obtain advertisements that they themselves desire at optimal locations and at appropriate times. Further, it also becomes possible to reflect registrants' own preferences based on their unconscious behavior, making it possible to realize the distribution of advertisements that elicit a high degree of satisfaction. In the meantime, for the advertisers that request advertisements, the present invention enables the efficient promotion of sales.

What is claimed is:

1. An advertisement distributing apparatus comprising a processing portion for distributing an advertisement to mobile communications devices, wherein said advertisement distributing apparatus further comprising:
a registrant file for registering people that receive the distribution of said advertisements;
a purchase history file for compiling histories of purchases realized as a result of said advertisements;
a behavior pattern file for compiling the behaviors of registrants by utilizing GPS (Global Positioning Systems);
a needs file for registering information set for advertisements that said registrants want distributed; and
an advertisement request file for storing data on advertisements to be distributed, and target data for specifying said advertisement targets,
wherein registrants to whom said advertisements are to be distributed are extracted from said purchase history file, said behavior pattern file, said needs file, and said target data.

2. The advertisement distributing apparatus according to claim 1, wherein said needs file is constituted to contain the results of registrant-selected settings regarding whether or not a purchase history can be compiled for creating said purchase history file, whether or not behavior patterns can be compiled for creating said behavior patterns file, and whether or not the distribution of said advertisements can be received.

3. A method for distributing advertisements to mobile communications devices, comprising the steps of:
classifying said registrants into a plurality of groups by analyzing the behavior of said registrants based on registrant histories of purchases of products and services, the locations of said registrants acquired using GPS, and information set regarding advertisements that said registrants want distributed;
sorting said groups by target data specifying advertisement targets; and
distributing said advertisements in accordance with the present locations of said registrants belonging to sorted said groups.

4. The advertisement distributing method according to claim 3, wherein said purchase histories are created by compiling the histories of non-purchases of either products or services relative to distributed said advertisements.

5. A mobile communications device that utilizes GPS, said mobile communications device being constituted such that there are settings in said mobile communications device for receiving advertisements, and the propriety setting for advertisement distribution, the propriety setting for compiling records of purchases of products or services, and the propriety setting for compiling location records for said mobile communications device are arranged on a display portion, and the results of these settings are displayed in a distinguishable condition.
